(19) United States
(12) Patent Application Publication
(10) Pub. No.: US 2025/0008263 A1
(43) Pub. Date: Jan. 2, 2025

(54) Audio Transducer Implementation Enhancements

(71) Applicant: Nokia Technologies Oy, Espoo (FI)

(72) Inventors: Miikka Tapani Vilermo, Siuro (FI); Koray Ozcan, Farnborough (GB)

(21) Appl. No.: 18/753,017

(22) Filed: Jun. 25, 2024

(30) Foreign Application Priority Data
Jun. 30, 2023 (GB) 2310048.0

(51) Int. Cl. H04R 3/00; H04R 1/40; H04R 3/04

(52) U.S. Cl. CPC H04R 3/005; H04R 1/406; H04R 3/04

(57) ABSTRACT

A method for generating audio signals for a device equipped with a transparency mode, the method including: obtaining at least two external audio signals from at least two microphones located on the device; determining at least one of sound direction or diffuseness or distance between a first microphone and a second microphone of the at least two microphones based on the at least two external audio signals; modifying at least one of the at least two external audio signals based on the determined at least one of sound direction or diffuseness or distance; and rendering the at least one modified audio signal.

### FIELD

The present application relates to apparatus and methods for audio transducer implementation enhancements, but not exclusively for audio transducer implementations enhancements for head mounted units and headphones related to spatial aspects.

### BACKGROUND

ANC (Active Noise Cancellation) and pass-through/transparency features are becoming more commonly implemented within a range of devices. For example ANC and pass through applications can be implemented within usual devices such as headphones. Furthermore ANC and passthrough implementations can be employed within a vehicle such as a car or within apparel such as motorcycle helmets, personal protection equipment (or PPE). ANC actively (using electronics, microphones and speaker elements) attenuates sounds from external sound sources for the user. A pass through/transparency mode in turn actively plays back external sound sources to the user so that the user can hear their surroundings (for example headphone users could hear cars around them and hear and talk to other people present in the same space). Ideally, in transparency mode the user would hear their surroundings clearly (for example for the headphone user as if they were not wearing headphones).

Many devices allow a user to select how much they hear external sounds and thus the device can gradually alternate between ANC and transparency modes.

Transparency mode in headphones does not produce a pure pass through signal when employing the audio signals from outer or external microphones as the generated transparency signal would not be the same as the audio signals experienced by the user because the outer microphones are not located in the user's ear canal. Additionally, differences between the generated pass through audio signals and the ‘experienced audio signals’ can be caused by the inner speakers or transducers are not located in the same place as the outer microphones and furthermore there is a filtering effect generated by the physical design of the device (which have a shape, volume, and weight that affects the audio signals).

For example where the device is a set of headphones the outer microphones are not located in the headphone user's ear canal. Furthermore in a car example device the microphones are mounted outside the vehicle and the speakers are either in their normal positions (in the doors, dashboard etc) or the speakers are in the driver's seat.

### SUMMARY

There is provided according to a first aspect a method for generating audio signals for a device equipped with a transparency mode, the method comprising: obtaining at least two external audio signals from at least two microphones located on the device; determining at least one of sound direction or diffuseness or distance between a first microphone and a second microphone of the at least two microphones based on the at least two external audio signals; modifying at least one of the at least two external audio signals based on the determined at least one of sound direction or diffuseness or distance; and rendering the at least one modified audio signal.

The at least two microphones located on the device may be located on one side of the device.

The at least two microphones located on the device may be located on opposite sides of the device.

The method may further comprise obtaining at least one internal audio signal, and modifying at least one of the at least two external audio signals is further based on the at least one internal audio signal.

The method may further comprise modifying the at least one of the at least two external audio signals based on a frequency profile to modify the at least two external audio signals more in lower frequencies.

The method may further comprise determining a distance between at least one of the at least two microphones located on the device and an associated speaker, wherein modifying at least one of the at least two external audio signals may further based on the distance between at least one of the at least two microphones located on the device and an associated speaker.

The device may comprise one of: a smartphone; a headphone; a vehicle equipped with the at least two microphones; a helmet equipped with the at least two microphones; and a personal protection equipment equipped with the at least two microphones.

The first microphone and the second microphone of the at least two microphones may be left and right side device microphones.

The first microphone may be a first set of microphones and a second microphone may be a second set of microphones.

Modifying at least one of the at least two external audio signals based on the determined at least one of sound direction or diffuseness or distance may be such that the modified audio signal direction or diffuseness are more correctly perceived by a user of the device.

According to a second aspect there is provided an apparatus for generating audio signals for a device equipped with a transparency mode, the apparatus comprising at least one processor and at least one memory storing instructions that, when executed by the at least one processor, cause the system at least to perform: obtaining at least two external audio signals from at least two microphones located on the device; determining at least one of sound direction or diffuseness or distance between a first microphone and a second microphone of the at least two microphones based on the at least two external audio signals; modifying at least one of the at least two external audio signals based on the determined at least one of sound direction or diffuseness or distance; and rendering the at least one modified audio signal.

The at least two microphones located on the device may be located on one side of the device.

The at least two microphones located on the device may be located on opposite sides of the device.

The apparatus may be caused to perform obtaining at least one internal audio signal, and the apparatus caused to perform modifying at least one of the at least two external audio signals may be further caused to perform modifying the at least one of the at least two external audio signals based on the at least one internal audio signal.

The apparatus may be further caused to perform modifying the at least one of the at least two external audio signals based on a frequency profile to modify the at least two external audio signals more in lower frequencies.

The apparatus may be further caused to perform determining a distance between at least one of the at least two microphones located on the device and an associated speaker, wherein the apparatus caused to perform modifying at least one of the at least two external audio signals may be further caused to perform modifying at least one of the at least two external audio signals based on the distance between at least one of the at least two microphones located on the device and an associated speaker.

The device may comprise one of: a smartphone; a headphone; a vehicle equipped with the at least two microphones; a helmet equipped with the at least two microphones; and a personal protection equipment equipped with the at least two microphones.

The apparatus may be integral to the device.

The device may comprise the apparatus.

The first microphone and the second microphone of the at least two microphones may be left and right side device microphones.

The first microphone may be a first set of microphones and a second microphone may be a second set of microphones.

The apparatus caused to perform modifying at least one of the at least two external audio signals based on the determined at least one of sound direction or diffuseness or distance may be such that the modified audio signal direction or diffuseness are more correctly perceived by a user of the device.

According to a third aspect there is provided an apparatus for generating audio signals for a device equipped with a transparency mode, the apparatus comprising means configured to: obtain at least two external audio signals from at least two microphones located on the device; determine at least one of sound direction or diffuseness or distance between a first microphone and a second microphone of the at least two microphones based on the at least two external audio signals; modify at least one of the at least two external audio signals based on the determined at least one of sound direction or diffuseness or distance; and render the at least one modified audio signal.

The at least two microphones located on the device may be located on one side of the device.

The at least two microphones located on the device may be located on opposite sides of the device.

The means may be configured to obtain at least one internal audio signal, and the means configured to modify at least one of the at least two external audio signals may be further configured to modify the at least one of the at least two external audio signals based on the at least one internal audio signal.

The means may be further configured to modify the at least one of the at least two external audio signals based on a frequency profile to modify the at least two external audio signals more in lower frequencies.

The means may be further configured to determine a distance between at least one of the at least two microphones located on the device and an associated speaker, wherein the means configured to modify at least one of the at least two external audio signals may further be configured to modify at least one of the at least two external audio signals based on the distance between at least one of the at least two microphones located on the device and an associated speaker.

The device may comprise one of: a smartphone; a headphone; a vehicle equipped with the at least two microphones; a helmet equipped with the at least two microphones; and a personal protection equipment equipped with the at least two microphones.

The apparatus may be integral to the device.

The device may comprise the apparatus.

The first microphone and the second microphone of the at least two microphones may be left and right side device microphones.

The first microphone may be a first set of microphones and a second microphone may be a second set of microphones.

The means configured to modify at least one of the at least two external audio signals based on the determined at least one of sound direction or diffuseness or distance may be such that the modified audio signal direction or diffuseness are more correctly perceived by a user of the device.

According to a fourth aspect there is provided an apparatus for generating audio signals for a device equipped with a transparency mode, the apparatus comprising: obtaining circuitry configured to obtain at least two external audio signals from at least two microphones located on the device; determining circuitry configured to determine at least one of sound direction or diffuseness or distance between a first microphone and a second microphone of the at least two microphones based on the at least two external audio signals; modifying circuitry configured to modify at least one of the at least two external audio signals based on the determined at least one of sound direction or diffuseness or distance; and rendering circuitry configured to render the at least one modified audio signal.

According to a fifth aspect there is provided a computer program comprising instructions [or a computer readable medium comprising instructions] for causing an apparatus, for generating audio signals for a device equipped with a transparency mode, the apparatus caused to perform at least the following: obtaining at least two external audio signals from at least two microphones located on the device; determining at least one of sound direction or diffuseness or distance between a first microphone and a second microphone of the at least two microphones based on the at least two external audio signals; modifying at least one of the at least two external audio signals based on the determined at least one of sound direction or diffuseness or distance; and rendering the at least one modified audio signal.

According to a sixth aspect there is provided a non-transitory computer readable medium comprising program instructions for causing an apparatus, for generating audio signals for a device equipped with a transparency mode, to perform at least the following: obtaining at least two external audio signals from at least two microphones located on the device; determining at least one of sound direction or diffuseness or distance between a first microphone and a second microphone of the at least two microphones based on the at least two external audio signals; modifying at least one of the at least two external audio signals based on the determined at least one of sound direction or diffuseness or distance; and rendering the at least one modified audio signal.

According to a seventh aspect there is provided an apparatus, for generating audio signals for a device equipped with a transparency mode, comprising: means for obtaining at least two external audio signals from at least two microphones located on the device; means for determining at least one of sound direction or diffuseness or distance between a first microphone and a second microphone of the at least two microphones based on the at least two external audio signals; means for modifying at least one of the at least two external audio signals based on the determined at least one of sound direction or diffuseness or distance; and means for rendering the at least one modified audio signal.

According to an eighth aspect there is provided a computer readable medium comprising instructions for causing an apparatus, for generating audio signals for a device equipped with a transparency mode, to perform at least the following: obtaining at least two external audio signals from at least two microphones located on the device; determining at least one of sound direction or diffuseness or distance between a first microphone and a second microphone of the at least two microphones based on the at least two external audio signals; modifying at least one of the at least two external audio signals based on the determined at least one of sound direction or diffuseness or distance; and rendering the at least one modified audio signal.

An apparatus comprising means for performing the actions of the method as described above.

An apparatus configured to perform the actions of the method as described above.

A computer program comprising instructions for causing a computer to perform the method as described above.

A computer program product stored on a medium may cause an apparatus to perform the method as described herein.

An electronic device may comprise apparatus as described herein.

A chipset may comprise apparatus as described herein.

Embodiments of the present application aim to address problems associated with the state of the art.

### SUMMARY OF THE FIGURES

For a better understanding of the present application, reference will now be made by way of example to the accompanying drawings in which:

FIGS. 1 to 3 show example differences within an example devices (headphones FIG. 1a and vehicle FIG. 1b) capacity with respect to positioning of external microphones and internal transducers (or ideally placed microphones) and where the direction-of-arrival of a sound source is from behind or oblique from the front angle relative to the device;

FIGS. 4 and 5 show example graphs show audio amplitude values for capture and playback with the example external microphones and internal transducers shown in FIGS. 1 to 3 with respect to a series of direction-of-arrivals of a sound source;

FIG. 6 schematically show example apparatus comprising inner and outer microphones and speaker transducers according to some embodiments;

FIGS. 7 and 8 show a flow diagram of the operation of the example apparatus shown in FIG. 6 according to some embodiments;

FIG. 9 schematically shows balanced left-right on axis positional or dimensional differences according to some embodiments;

FIGS. 10a to 10c show on-axis, parallel-to-axis, and off-axis positional or dimensional differences;

FIG. 11 shows example phase differences caused by balanced left-right on axis positional or dimensional differences such as shown in FIG. 9;

FIG. 12 schematically shows unbalanced left-right on axis positional or dimensional differences;

FIG. 13 shows example phase differences caused by unbalanced left-right on axis positional or dimensional differences such as shown in FIG. 129;

FIG. 14 shows a flow diagram of the operation of the example apparatus according to some embodiments;

FIG. 15 schematically shows balanced left-right parallel-axis positional or dimensional differences according to some embodiments;

FIG. 16 schematically shows unbalanced left-right parallel-axis positional or dimensional differences;

FIGS. 17 and 18 show example graphs of the effect of more stable and improved spatial transparency audio signal (overcoming the acoustic leakage) with frequency band dependent direction/diffuseness correction; and

FIG. 19 shows schematically an example apparatus suitable for implementing some embodiments.

### EMBODIMENTS OF THE APPLICATION

As discussed previously current transparency or passthrough modes for suitable devices equipped with ANC functionality produces transparency audio signals which differ from the ideal or expected audio signals. This difference is because of the relative differences between the external or outside microphones and the internal transducers or speakers and further the filtering aspects of the headphones themselves. Additionally, the quality between ideal and generated transparency audio signals where the transparency method considers audio signals from only one of the two microphones.

In addition, when listening to loud music volumes, the natural representation of the surrounding audio signals in a transparency mode may not be enough to enable the user to accurately detect all of the sound sources around them.

In order to render spatial audio, there are several characteristics that need to be implemented correctly. In particular, the characteristics that should be implemented correctly to produce good quality audio signals are direction and diffuseness. Direction is important for safety reasons to be able to hear, for example, obstacles or dangers such as car directions and diffuseness also provides the user valuable clues to sound object distances and intelligibility of speech.

Upcoming Immersive Voice and Audio Services (IVAS) standard and Immersive Voice applications are configured to provide immersive audio communications. This type of communication system is more immersive meaning that the mixing of far-end ambience sounds and local ambience environment can result in a confusing output audio signal. Increasing the clarity of local spatial audio environment is therefore a current research topic being investigated.

In the following examples the device shown is a headphone device, however it would be appreciated that the same methods and apparatus for implementing embodiments can be applied to other devices.

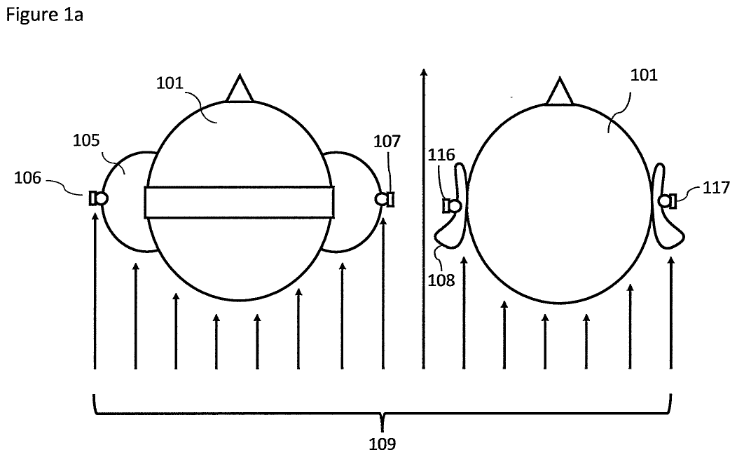

A first example of the difference between real and ideal microphone positions and their effect with respect to transparency modes can be shown with respect to FIGS. 1a and 1b. In FIGS. 1a and 1b the example audio source 109 generates audio signals from behind the user 101. The user 101 is shown on the left side with respect to the headphones 105 in FIG. 1a and vehicle 155 in FIG. 1b and the external or outer microphones (shown as left outer microphone 106, 156 and right outer microphone 107, 157) which is in direct line of the audio source. However, the user 101 is shown on the right side with respect to the ideal microphone positions (shown as left ideal microphone 116, 166 and right ideal microphone 117, 167) which are located internally in the ear canal and would effectively be in audio shadow with respect to the audio source 109, and blocked by the ear 107 or vehicle body 158. Thus, sounds coming from behind to a user's ears are shadowed by earlobes. However, sound arriving to microphones on the earcups in the locations shown in the FIGS. 1a and 1b are not shadowed. If the microphones on the earcups are used to generate pass-through sound, a user cannot use the shadowing effect to separate sounds from behind from sounds from frontal direction. This makes perceiving directions from behind when wearing headphones and in the vehicle more difficult than necessary.

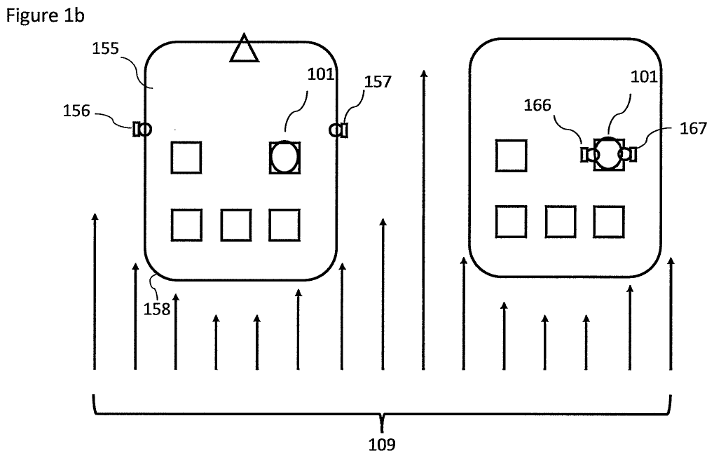

A further example of the difference between real and ideal microphone positions and their effect with respect to transparency modes can be shown with respect to FIG. 2. In FIG. 2 the example audio source 209 generates audio signals from in front and at an angle to the user 101. The real microphones 106/107 and ideal microphones 116/117 positions are similar to that described with respect to the example shown in FIG. 1. In this example sound coming from front right arrives without shadowing and thus with the same level to both of the microphones on the earcups. The same sound is shadowed with respect to the ideal left microphone 116 in the left ear. Therefore, there is little level difference for this captured sound in the microphones but there is a level difference for a user (without headphones—the ideal user microphone positions). If the microphones on the earcups are used to generate pass-through sound, a user cannot use the shadowing effect to determine the direction of the sound source.

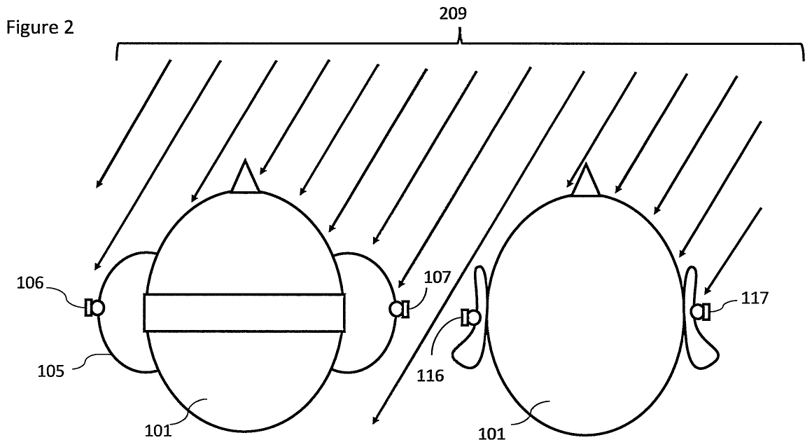

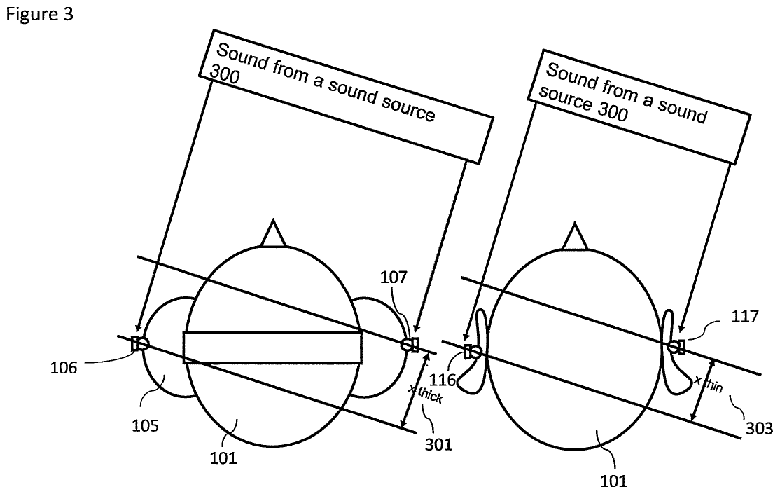

Furthermore FIG. 3 shows an example where the difference between positions effects not only shadowing effects but also time differences. In FIG. 3 the example audio source 300 generates audio signals from in front and at an angle to the user 101. The real microphones 106/107 and ideal microphones 116/117 positions are similar to that described with respect to the example shown in FIG. 1. In this example it is shown that with (thick) headphones the microphones 106/107 are far away from the ears and thus the time difference of sound arriving to left and right microphones from a direction is markedly bigger than microphones 116/117 within the ears when sound arrives to left and right ears. This difference shown by the distances 301 and 303 makes direction perception different in transparency mode with different thickness headphones. Also, when two microphones are close to each other they capture a less diffuse sound than when they are far apart. Thus, the difference in position (created by the thickness of the headphones) has an effect on the diffuseness too. The thicker the headphones, the more diffuseness should be reduced in the transparency signal to make the audio sound as it would without the headphones.

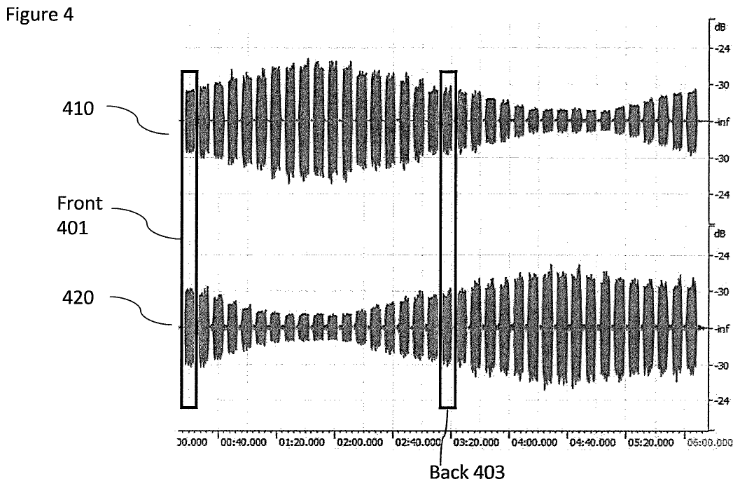

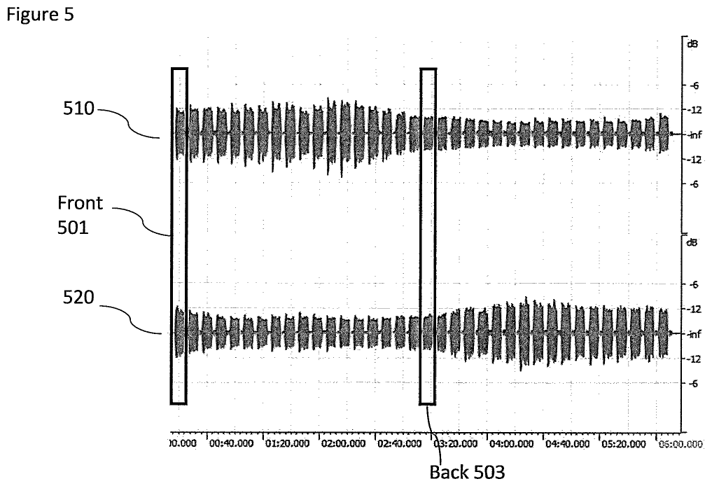

This effect is further demonstrated by the graphs in FIGS. 4 and 5. In these examples a white noise was played in an anechoic chamber to a mockup artificial head with microphones in ideal and mockup headphones positions approximately 3 cm outside the head. One microphone was on the right side (right microphone) and two microphones were on the left side (left and front microphones).

FIG. 4 shows for example the signals in the left 410 and right 420 microphones from the ideal microphones as the white noise is played to left and right microphones from 36 directions on a horizontal plane around the device with 10 degree separation between directions. Sound from the front direction is found inside box 401, sound from the back directions is found inside box 403. It can be seen that the shadowing effect produces distinct changes as the sound moves round the head.

FIG. 5 shows the same but for the left 510 and right 520 microphones on the headphones. Sound from the front direction is found inside box 501, sound from the back directions is found inside box 503. It can be seen that the lack of shadowing effect produces audio signal which are less distinct as the sound moves round the head.

In other words, since the microphones are not located where the ear canal would be, the head has little effect on the microphone signals and the signal as shown in the graph in FIG. 5 is produced. The figure has only left and right microphone signals that would typically be used for a transparency signal. This signal can be improved to be more like an ‘ideal’ audio signal that a human being would hear using binauralization from the three microphones using known methods. The level difference between sound coming from front and back (red and blue boxes in the figures) is insignificant in FIG. 5 but more correct in FIG. 4.

As indicated above a similar issue would occur for other devices. For example the in a vehicle situation the microphones can be mounted outside the vehicle and the speakers are located in conventional positions (in doors, dashboard etc) or as a soundbar configuration or located within a seat of the user (such as the driver). Similarly the motorcycle helmet or head mounted PPE protection implementation can be one in which the microphones are mounted on the exterior but the microphones mounted inside the helmet/PPE.

In some embodiments there is provided a headphone (or suitable apparatus and methods) that has a transparency mode where microphone signals are compared to estimate sound direction and/or diffuseness and/or distance of between left and right earcups/earspeakers (or more generally microphone and speaker positions) and a transparency signal is modified so that the direction and diffuseness are more correctly perceived by the user. In some embodiments a (headphone) transparency signal is modified more in the low frequencies.

In some embodiments, there is also provided suitable apparatus (for example headphones, vehicles or apparel) and methods that have a transparency mode where microphone signals from both microphone positions (for example the earcups in headphones) are compared to estimate sound direction and/or diffuseness and transparency signal is modified so that the direction and diffuseness are more correctly perceived by the user. In some embodiments a (headphone) transparency signal is modified more in the low frequencies.

In some embodiments, there is also provided suitable apparatus and methods that have a transparency mode where microphone signals are compared to estimate sound direction and/or diffuseness and transparency signal is modified so that the direction of sound sources is unnaturally clear in particular when the internal signal (music) from the device connected to the device is loud. In some embodiments a transparency signal is modified more in the low frequencies.

Furthermore, in some embodiments, there is also provided suitable apparatus and methods that have a transparency mode where microphone signals from both microphone positions (such as earcups on a headphone) are compared to estimate sound direction and/or diffuseness and transparency signal is modified so that the direction of sound sources is unnaturally clear in particular when the internal signal (music) from the device connected to the device or apparatus is loud. In some embodiments both (earcup) microphones are compared to achieve a perceptually better estimate. In some embodiments a (headphone) transparency signal is modified more in the low frequencies.

Additionally in some embodiments there is also provided a suitable apparatus and methods (such as headphones) that are configured to reduce the phase difference and diffuseness of at least two microphone signals and creates a transparency signal from the modified microphone signals using information about) distance(s) from the outer microphones to the inner speakers (for example the headphone thickness). The amount by which the spatial parameters are modified (smaller) is based on the distances amount.

In the following examples the concept as discussed herein can be implemented in any suitable headphones or headset. In some embodiments the headphones may be in-ear or over-the-ear type. The headphones may have a head band or not (for example may be earbuds or earphones which at least partially are located within or against or adjacent the ear canal). In embodiments where both cup microphones are used to create a transparency signal, the microphone signals are transmitted to both earcups. In headphones with a head band this can be implemented using cables, in headphones without a headband then a suitable wireless transmission is employed, such as Bluetooth.

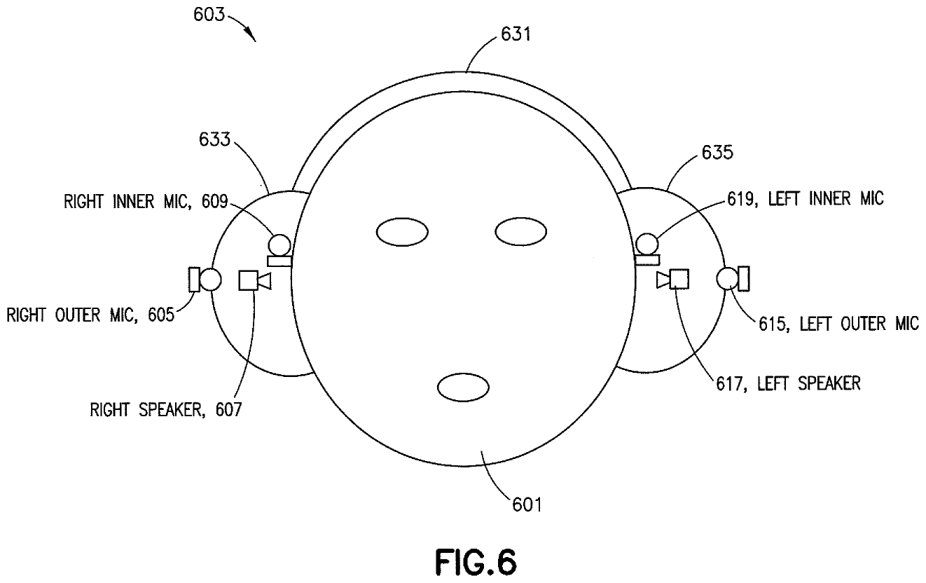

With respect to FIG. 6 is shown an example apparatus which can implement some embodiments. In this example the user 601 is wearing headphones 603 equipped with a headband 631, a left ear cup 635 and right earcup 633. The left earcup 635 in this example comprises at least one left outer (external) microphone 615 that records sounds from outside the headphones and a speaker 617 that is configured to play or output the transparency signal and sounds from a suitably connected (either wirelessly or by cable) device. The device can for example be a mobile phone, laptop, PC or any suitable electronic apparatus. The left earcup 635 in some embodiments can further comprise at least one inner microphone 619 that is configured to record sounds from inside the headphones, between the left speaker 617 and the user's eardrum.

Similarly, the right earcup 633 in this example comprises at least one right outer (external) microphone 605 that records sounds from outside the headphones and at least one right speaker 607 that is configured to play or output the transparency signal and sounds from the suitably connected device. The right earcup 633 in some embodiments can further comprise at least one inner microphone 609 that is configured to record sounds from inside the headphones, between the right speaker 607 and the user's eardrum.

In some embodiments there is provided a device (for example headphone) that has a transparency mode where microphone signals are compared to estimate sound direction and/or diffuseness and the generated transparency signal is modified so that the direction and diffuseness are more correctly perceived by the user.

In some embodiments the audio signals from the microphones in the left ear cup (or more generally ‘left’ side microphone(s)) can be used to create a left transparency signal and the microphones in the right ear cup (or more generally ‘right’ side microphone(s)) can be used to create a right transparency signal. In this way there does not need to be any signal transmission between the two ‘sides’ of microphones or earcups. In these embodiments the total minimum number of microphones is four, two on each side (or in each earcup).

In such embodiments the device (headphones) use at least two microphone signals to analyse sound directions using e.g, methods in U.S. Pat. No. 9,456,289 and/or diffuseness as in GB1619573.7. Diffuseness can be estimated as D/A ratios (Direct-to-Ambient). These parameters can in some embodiments be analysed in frequency bands. In some embodiments there can be 20-50 frequency bands but the embodiments as discussed herein can be applied to implementations with one or more frequency band. In some embodiments a smaller number of frequency bands can help reduce the time it takes to analyse the parameters.

In some embodiments the left/right direction is estimated and a front/back ambiguity is left unsolved. This allows correcting the level and/or phase of the pass-through signal for left/right separation and ignores the front/back separation. The front/back direction separation can be used to include the effect of the shadowing (for example shadowing of the earlobes which can be the largest single contributor with respect to the head but the effect is not as strong as the shadowing of the human head in the case of left/right separation). Additionally solving only the left/right direction can be implemented with fewer microphones. For example, a minimum 2 of two microphones can be used to determine the left/right separation.

A right outer microphone audio signal can be equalized in frequency bands and fed to the same (earcup) loudspeaker to create the transparency signal. A similar approach can be applied to the left where the left outer microphone audio signal can be equalized in frequency bands and fed to the same left (earcup) loudspeaker or ‘left’ virtual loudspeaker in a soundbar to create the transparency signal for the left channel.

The equalization processing for the outer microphone audio signals is implemented as different frequencies leak differently acoustically through the headphones or vehicle or helmet or head mounted device to the user ear. With equalization the transparency signal compensates for the parts of the audio signal that the headphones passively attenuate from the leaked signal. The passive attenuation for headphones is higher in higher frequencies and thus the transparency signal level is higher in higher frequencies. For the same reason, the modifications implemented in some embodiments are applied more (and at higher levels of modification) within the lower frequencies where the leaked sound forms a large part of the lower frequencies.

In some embodiments the equalization is controlled based on the detected directions. The equalization is applied such that the difference in level in frequency bands between the left and right earcup transparency signal corresponds to a binaural signal from the detected direction. The level differences for the binaural signals can be obtained or determined from a stored database or similarly stored form. The database may be a general one or personalized for the current user.

In a more complex embodiment implementation a diffuseness of the audio signal is taken into account. The level difference between the left and right microphone audio signals (or in headphones the earcups) is modified to be the product of the D/A ratio and the level difference for a dry sound coming from the detected direction. The dry sound level difference is known as ILD (Inter-aural Level Difference) and values for different directions can be found form known databases. Alternatively, in some embodiments a user's own measured or estimated level difference can be used. The determination of a user/s own measured or estimated level difference can be implemented according to any known method.

In some embodiments the device (for example headphones or headset/earbuds, vehicle etc) based audio signals can additionally be modified with device specific values. In some embodiments the sound environment is estimated to be fully diffuse (typically D/A ratio is zero or close to it) then the product i.e. final level difference should be zero and if the sound environment is fully directional (D/A ratio is one or close to it) then the product, in other words the final level difference, should be the same as the dry level difference.

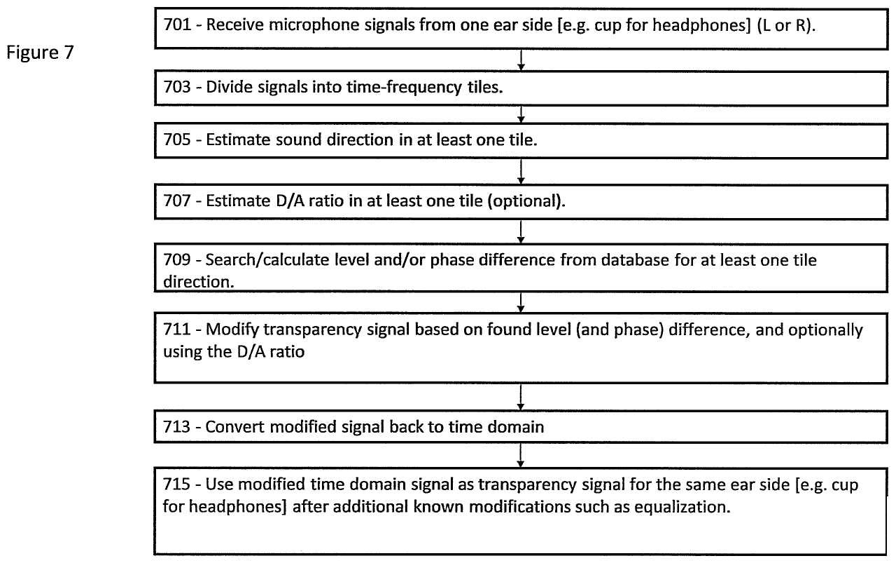

The method is further shown in the operations shown with respect to FIG. 7.

With respect to step 701 there is shown the operation of receiving microphone signals from one side (L or R), which in headphones can be one ear cup.

Then with respect to step 703 there is shown the operation of dividing signals into time-frequency tiles.

As shown in step 705 is the operation of estimating sound direction in at least one tile.

Additionally, is shown in step 707 the operation of estimating D/A ratio in at least one tile. This estimation operation is an optional step.

Furthermore, is shown in step 709 the operation of searching/calculating (or otherwise obtaining or determining) a level and/or phase difference from a database for at least one tile direction (or suitable storage means).

Then as show in step 711 is the operation of modifying transparency signal based on the obtained or found level (and phase) difference, and optionally using the D/A ratio.

Step 713 furthermore shows converting the modified signal back to a time domain representation.

Finally step 715 shows the operation of using a modified time domain signal as the transparency signal for the same side (which in headphones can be the same side ear cup) after additional known modifications such as equalization are implemented.

In some embodiments the diffuseness of the transparency signal can also be modified based on measured diffuseness by decorrelating or correlating the transparency signal so that its diffuseness matches the measured diffuseness from the outer microphones. Decorrelating a signal can be implemented using known decorrelators and correlating a signal can be implemented, for example, by mixing the signal stereo transparency signal with its mono downmix.

Additionally, in some embodiments transparency (i.e. pass-through) signal should be presented to the user with very little delay. Direction and D/A ratio analysis may take some time (e.g. 20 ms or more) depending on the method employed. Typically, important directions and D/A ratio such as emergency vehicle sounds in audio do not change very quickly whereas less important directions such as ambient noise direction can vary rapidly. Therefore, the system may use directions and D/A ratio from earlier audio samples and use them to adjust current samples in the transparency signal without causing significant problems. Some direction detection methods are very fast though. For example, the level difference of the microphone signals can be directly mapped to a desired level difference in the transparency signal using measured data from the headphones where the measured data is stored in a table. Additionally or alternatively, higher sampling rates such as 192 KHz can be used for analysis to reduce the delay.

In addition or alternatively to level changes, the phase of the transparency signal can also be changed to match values in a database. Phase changes can be implemented using known methods. Typically, phase changes are more important at lower frequencies (<1.5 kHz) and level change is more important at higher frequencies (>1.5 kHz).

Furthermore, in some embodiments the changes are implemented to the transparency signal so that the changes minimally modify the original transparency signal. In these embodiments there is a focus on the difference of the level and phase of the left and right transparency signals. Therefore, both signals are modified minimally so that the difference is the same as in the database.

A more detailed example implementation is presented hereafter.

In this example two microphones are located on or close to a left/right axis on the device. This example can therefore solve the problem as shown in FIG. 2 where the audio source is from an angle but would not aid in the front/rear determination problem shown in FIG. 1. The occurrence in the difference of sound coming from front or behind is quite small compared to the difference of sound coming from right or left. The device in this example has two microphones m=1,2 and they produce the following signals:

xₘ(k),m=1,2

Microphone 1 in this example is used for creating left ear transparency audio signals and microphone 2 for right ear transparency audio signals.

In some embodiments the first operation is to filter the microphone audio signals with a filterbank to enable processing in frequency bands, for example using:
https://researchgate.net/publication/225876013_Low_Delay_Filter-Banks_for_Speech_and_Audio_Processing

Other filterbanks or time-to-frequency domain transforms may be employed (though as discussed a very low delay method such as the one discussed above is preferred). A low delay approach is employed because a headphone (or more generally the device) user can typically hear the sound sources through the speakers or headphones as well as the transparency signal and any significant delay between the two can create a situation where the user hears the sound sources twice.

The filtered signal with B bands is:

$${X}_{m}^{b} ( k ) , b = 0 , … , B - 1$$

In low frequency bands direction is analysed from time difference between signals.

$${τ}_{b} = {max}_{n} {\sum }_{k = {N}_{i}}^{{N}_{i + 1} - 1} ( {X}_{I}^{b} ( k ) * {X}_{2}^{b} ( k - n ) )$$

where τ_{b} is time difference in each band and Nᵢ is an index that shows the limits of ith analysis window. The analysis window should be quite small to reduce any delay. Typically the analysis window can be 10 ms or less.

Time difference is converted into an effective distance

$${Δ}_{12} = \frac{v {τ}_{b}}{{F}_{s}}$$

where Fₛ is sampling frequency and vis speed of sound.

Effective distance can be converted into a direction is each low frequency band.

$${α}_{b} = \pm {cos}^{- 1} ( \frac{{Δ}_{23}^{2} + 2 b {Δ}_{23} - {d}^{2}}{2 d b} )$$

where d is the distance between microphones and b is the estimated distance between sound sources and nearest microphone. Typically b can be set to a fixed value. For example b=2 meters has been found to provide stable results. The determined direction is an azimuth direction.

The direction although being ambiguous because there are two microphones. In some embodiments where there are three or more microphones, the ambiguity can be solved as explained in U.S. Pat. No. 9,456,289.

At higher frequencies the time difference of sound reaching the two microphones may be large compared to the wavelength of sound, that it is better to use level based direction analysis. Energy of microphone signals in frequency bands can be calculated as:

$${E}_{m}^{b} = {\sum }_{k = {N}_{i}}^{{N}_{i + 1} - 1} {( {X}_{m}^{b} ( k ) )}^{2}$$

### Energy Difference Between Microphone Signals:

E₁^{b}−E₂^{b}
which can be compared to a database to find closest values. The database contains energy differences for known sound directions. The comparison provides then direction estimates for each higher frequency band.

Once the direction for each band is determined, the audio signals in the bands are modified to better reflect human hearing without the headphones. The direction is used to search from a HRTF (Head Related Transfer Function) database left and right ear level and phase differences that correspond to that direction in each frequency band.

HRTFs are typically provided given as frequency response bins for frequency indexes for both sides (left and right) for different directions. HRTF average energy in band b (the same bands are used here as in the filterbank previously) for left l ear and direction a is:

$${E}_{l , α}^{b} = {\sum }_{k = {M}_{b}}^{{M}_{b + 1} - 1} \frac{{( {HRTF}_{l , α} ( k ) )}^{2}}{{M}_{b + 1} - {M}_{b}}$$

where M_{b} is an index that shows the limits of frequency response bins for band b and the HRTF_{l,α} function is readily available in known HRTF databases. The level differences of left and right HRTFs is:

E_{lα}^{b}−E_{r,α}^{b}

In these embodiments the pass-through signal is configured to have the same level difference in each band. For example if the direction in a band was estimated to be a then the following is:

$${\sum }_{k = {N}_{i}}^{{N}_{i + 1} - 1} \frac{{( {g}^{b} {X}_{1}^{b} ( k ) )}^{2}}{{N}_{i + 1} - {N}_{i}} - {\sum }_{k = {N}_{i}}^{{N}_{i + 1} - 1} \frac{{( \frac{{X}_{2}^{b} ( k )}{{g}^{b}} )}^{2}}{{N}_{i + 1} - {N}_{i}} = {E}_{l , α}^{b} - {E}_{r , α}^{b}$$

where g is a gain to amplify one of the signals and to attenuate the other. In these embodiments the method is configured to modify the signals overall as little as possible since in general all modifications cause artefacts. The previous equation results in g being:

$${g}^{b} = \sqrt[2]{\frac{{E}_{l}^{b} - {E}_{r}^{b} + \sqrt[2]{{( {E}_{l}^{b} - {E}_{r}^{b} )}^{2} + \frac{4}{{N}_{i + 1} - {N}_{i}} {\sum }_{k = {N}_{i}}^{{N}_{i + 1} - 1} {( {X}_{1}^{b} ( k ) )}^{2} {\sum }_{k = {N}_{i}}^{{N}_{i + 1} - 1} {( {X}_{2}^{b} ( k ) )}^{2}}}{\frac{2}{{N}_{i + 1} - {N}_{i}} {\sum }_{k = {N}_{i}}^{{N}_{i + 1} - 1} {( {X}_{1}^{b} ( k ) )}^{2}}}$$

### The Audio Signals

Xₘ^{b}
are modified in frequency bands so that the modified audio signals have the same level and phase differences as indicated by the HRTF database. In some cases only one of the two is used and in most typical cases phase difference is used for low frequency bands and level difference is used for high frequency bands.

For example, if microphone 1 is used for creating a pass-through signal for the left side or channel (or ear) and microphone 2 is used for creating a pass-through signal for the right side or channel (or ear) and the level difference of left and right sides is as previously discussed and the phase difference in the HRTF database:

$$phase\_diff ( b , α )$$

$${X}_{m -}^{b} modified ( k ) = {g}^{b} {X}_{m}^{b} ( k + phase\_diff ( b , α ) )$$

In some embodiments, diffuseness is taken into account as well. Diffuseness can be measured using known methods, typically correlation between microphone signals. Diffuseness is often measured as D/A ratio. If the audio scene around the user is very diffuse, then it can be difficult to hear any clear audio directions and the modifications described above can be reduced or ignored altogether. For example where diffuseness has been estimated using known methods and is available as D/A ratio for each band so that if D/A ratio is zero, audio is very diffuse, and if D/A is 1, audio is very direct (the opposite of diffuse) and D/A ratio may get any values in between 0 and 1 to correspond to all kinds of level of diffuseness.

In some embodiments the earlier equation can be modified to the following:

$${X}_{m -}^{b} modified ( k ) = DAratio \cdot {g}^{b} \cdot {X}_{m}^{b} ( k + {phase}_{diff ( b , α )} ) + ( 1 - DAratio ) \cdot {X}_{m}^{b} ( k + phase\_diff ( b , α ) )$$

In some embodiments where the microphones are very close to each other, diffuseness estimation methods may underestimate the amount of diffuseness that user would hear without headphones. Diffuseness may then be added to the signals by decorrelating the signals using known methods.

In some embodiments, at lower frequencies (<1.5 kHz) and increasingly towards lower frequencies than this, a larger modification is applied, because at lower frequencies the transparency signal forms only a small part of the audio user hears because at low frequencies environmental sounds leak through the headphones. The leakage depends on the headphones, typically over the ear type headphones have less leakage than in-ear headphones but this also depends on how tightly fitted the headphones are. Typically, the modification factor could be 1.5-2.0 for both the gain and phase at low frequencies.

In some embodiments the modified signals can then be input to an inverse filterbank that can be as simple as summing all the signals or more complex in the situations of applying time-frequency domain transforms. The result is used for creating a pass through signal.

In some embodiments further processing can be applied before or after these operations, such as analogue-to-digital (A/D) conversion, digital-to-analogue (D/A) conversion, compression, equalization (EQ), etc.

In some situations with many sampling rates (<48 kHz in particular) using full sample delay for phase may not be accurate enough. Therefore, a fractional delay may be applied.

Although in the above examples there are no smoothing operations described for simplicity and clarity reasons, however a typical implementation can implement smoothing.

In some embodiments there can be a headphone that has a transparency mode where microphone signals from both earcups are compared to estimate sound direction and/or diffuseness and transparency signal is modified so that the direction and diffuseness are more correctly perceived by the user.

Implementation wise this is similar to the above described embodiment implementations. The difference between these and the above implementations is that when microphones from both earcups are used, there are microphones whose pairwise distance is more similar to the distance between the user's ears and therefore the estimate of the direction and/or diffuseness are more similar to the directions and/or diffuseness that a human (not wearing headphones) would perceive. For both left and right ear transparency audio signals, both microphones from left and right earcups are used. In these embodiments a minimum total number of microphones is two, one in each earcup.

In these embodiments the best performance is experienced when both earcups of the headphone are connected with a wired connection so that there is insignificant delay when processing microphone signals from both earcups.

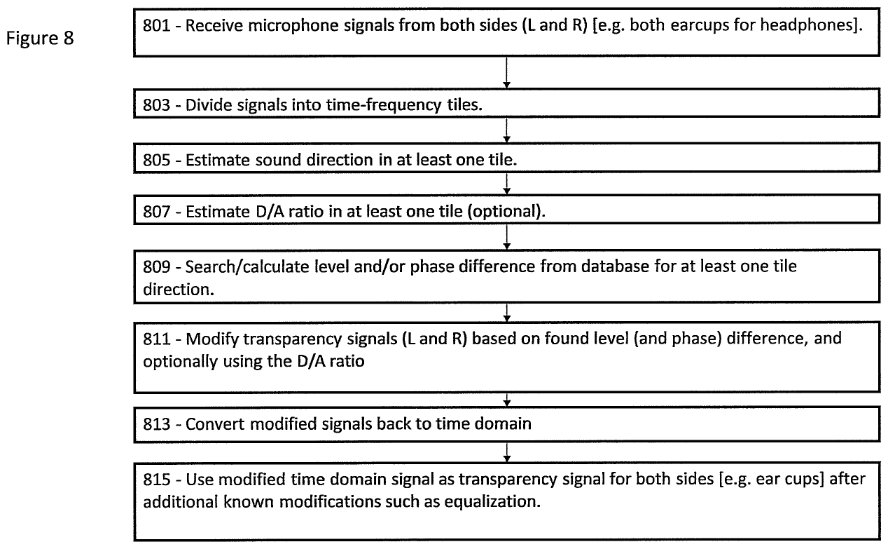

The method is further shown in the operations shown with respect to FIG. 8.

With respect to step 801 there is shown the operation of receiving microphone signals from both sides (L and R), which for headphones can be both ear cups (L and R).

Then with respect to step 803 there is shown the operation of dividing signals into time-frequency tiles.

As shown in step 805 is the operation of estimating sound direction in at least one tile.

Additionally is shown in step 807 the operation of estimating D/A ratio in at least one tile. This estimation operation is an optional step.

Furthermore is shown in step 809 the operation of searching/calculating (or otherwise obtaining or determining) a level and/or phase difference from a database for at least one tile direction (or suitable storage means).

Then as show in step 811 is the operation of modifying transparency signal (L and R) based on the obtained or found level (and phase) difference, and optionally using the D/A ratio.

Step 813 furthermore shows converting the modified signal back to a time domain representation.

Finally step 815 shows the operation of using a modified time domain signal as the transparency signal for both sides or ear cups after additional known modifications such as equalization are implemented.

The processing equations are the same as discussed above but the microphone locations are different.

In some embodiments the device (headphone) is configured with transparency mode where microphone signals are compared to an estimated sound direction and/or diffuseness and transparency audio signals are modified so that the direction of sound sources is unnaturally clear in particular when the internal signal (music) from the device connected to the device is loud.

As hearing surrounding environmental sounds can be vital, for example in traffic. The ability to determine or hear audio signals from the correct directions (for example in big cities with lots of echoes from buildings) can be difficult even without headphones. Any degradation in the ability to determine directions because of the headphones can be problematic. Users can get distracted by for example loud music played from (within) the headphones or vehicle or helmet. The louder the music the more difficult it is to hear dangerous sound sources around you in real life.

Although there have been proposed many ways that can be used to give the user a ‘super’ hearing for sound directions, few are suitable for use in with transparency mode because of the ultra-low latency requirements. In some embodiments a proposed low-latency approach is presented below:

In some embodiments a low-latency filterbank is used to divide microphone signals, typically one from both sides or earcups into frequency bands. The louder of the microphones is chosen for each band. The louder signal is used as a transparency signal (+ other known modifications employed) in both ears but a level difference is introduced to the left and right ear transparency signals in each band. The level difference is the same as in the original microphone signals or the level difference is based on a detected direction similar to the earlier embodiments described above. This modification can in some situations causes artefacts in the transparency audio signal and therefore the modified signal is typically mixed with a normal or conventional (non-modified) transparency signal. The mixing depends on the loudness of the music from the user device. The louder the music the more the modified signal is used in the mixture. The modification achieves a reduction in diffuseness and in this way the directional hearing of the user is improved.

In some embodiments this can be implemented based on the above equation.

$${X}_{m -}^{b} modified ( k ) = ML \cdot {g}^{b} \cdot {X}_{m}^{b} ( k + {phase}_{diff ( b , α )} ) + ( 1 - ML ) \cdot {X}_{m}^{b} ( k + phase\_diff ( b , α ) )$$

In these embodiments the equation replaces the D/A ratio with a ML value, where ML stands for Music Level and can be set as a value of 1 for high music level and a value of zero for low music level.

In some embodiments the modifications performed herein may need to be employed in a greater manner with respect to the lower frequencies where the leaked sound forms a large part of the lower frequencies.

In very diffuse conditions sounds may appear to be coming from a wrong direction because of a strong reflection. In such circumstances the application of the modification can produce a poorer performance. The modification can thus in some embodiments be limited so that in diffuse situations (diffuseness is measured with D/A ratio), the amount of the modified signal is limited in the mixture.

In some embodiments the device or headphone has a transparency mode where microphone signals from both sides or earcups are compared to estimate sound direction and/or diffuseness and transparency signal is modified so that the direction of sound sources is unnaturally clear in particular when the internal signal (music) from the device connected to the device or headphones is loud.

In such a manner the implementation can be similar to the ‘both’ sides or earcup modification as discussed above but when microphones from both sides or earcups are used, there are microphones whose pairwise distance are more similar to the distance between user ears and therefore the estimation of the direction and/or diffuseness is more similar to the perception of the user without headphones.

In a similar manner this embodiment is better when both sides (or earcups of the headphone) are connected with a wired connection so that there is insignificant delay for using microphone signals from both sides or earcups. In some embodiments a wireless connection between the device sides, for example the in-ear headphones, can be implemented, but the performance due to the additional delay can be poorer.

As described above a ‘thickness’ refers to the distance of the microphones from speaker elements on a line parallel to the axis defined by the users ears. The ‘thickness’ thus in the current application does not refer to the thickness of the headphones or more generally the device as a whole.

In the following embodiments there are benefits even when the microphones are not perfectly on a line that is parallel to the axis defined by the ears of the user but the result of the application in these situations are less optimal.

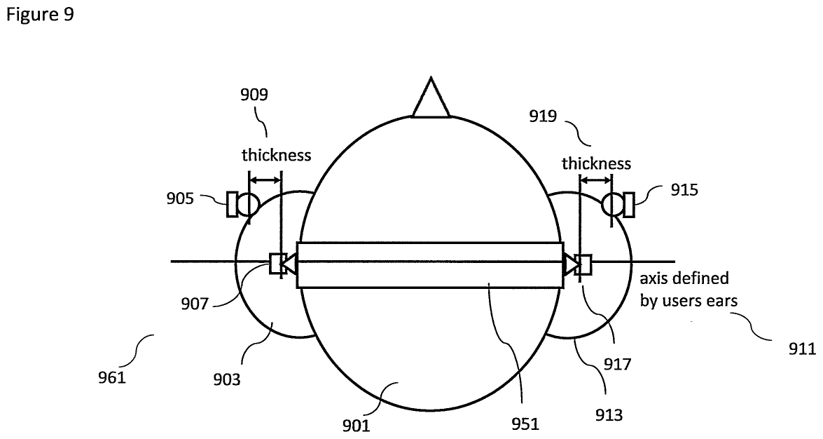

Thus, for example thickness is shown with respect to FIG. 9. FIG. 9 shows a user 901 wearing headphones 961. The headphones 961 comprise a headband 951 and left earcup 903 and right earcup 913. The left earcup 903 has within it a left external microphone 905 and left internal speaker 907 which are separated by a left thickness 909. The right earcup 913 has within it a right external microphone 915 and right internal speaker 917 which are separated by a right thickness 919. In this example the thickness is defined with respect to an axis 911 defined by the user's ears.

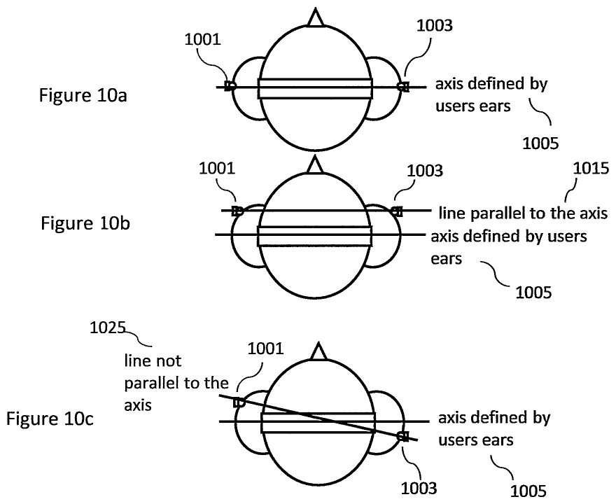

Additionally, is shown in FIGS. 10a to 10c examples where, for example FIG. 10a the microphones 1001 and 1003 are on the axis defined by the user's ears 1005, FIG. 10b the microphones 1001 and 1003 are on an axis 1015 parallel to the axis 1005 defined by the user's ears, FIG. 10c the microphones 1001 and 1003 are on an axis 1025 not parallel to the axis 1005 defined by the user's ears.

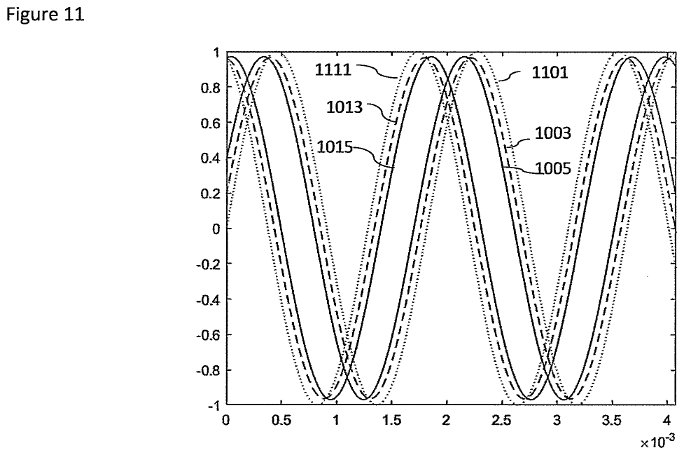

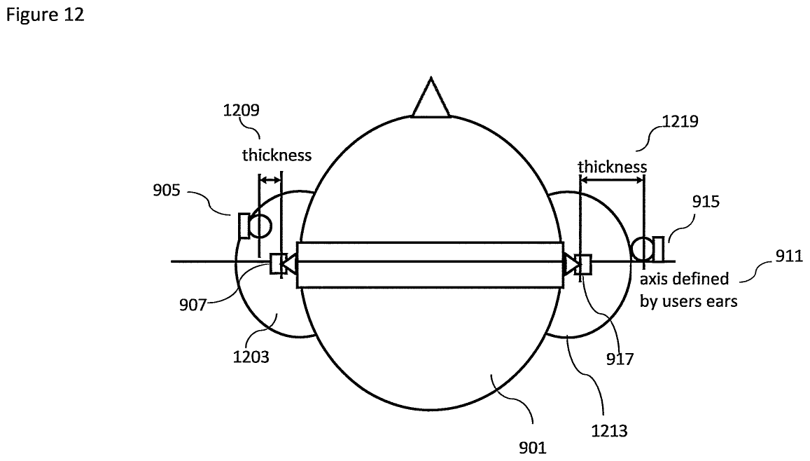

With respect to FIG. 11 is shown an example simulation result following a signal modification. In the example shown there are two sinusoidal signals (dotted lines) 1001 and 1011 with the same frequency but different phases. However, these are moved closer to each other in phase by using Mid/Side modification. Thus are shown in FIG. 11 the dashed lines 1003 and 1013 and solid lines 1005 and 1015 which show where the signals that are modified are closer in phase with different levels of modification.

In some embodiments the left and right thickness values can differ as shown with respect to FIG. 11. FIG. 11 shows a user 901 wearing headphones 961. The headphones 961 comprise a headband and left earcup 1203 and right earcup 1213. The left earcup 1203 has within it a left external microphone 905 and left internal speaker 907 which are separated by a left thickness 1209. The right earcup 1213 has within it a right external microphone 915 and right internal speaker 917 which are separated by a right thickness 1219. In this example the left thickness 1209 is smaller than the right thickness 1219 and is defined with respect to an axis 911 defined by the user's ears.

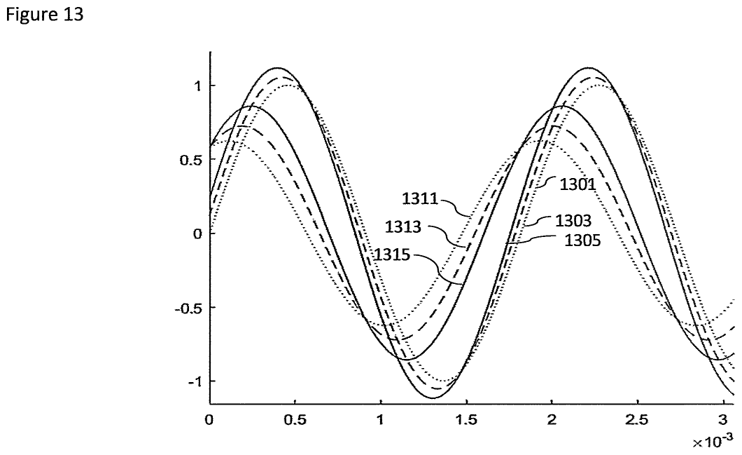

As shown in FIG. 13 the difference between left and right thicknesses can result in the audio signals being modified differently. In FIG. 13 when compared to the audio signals of FIG. 11 shows that the right microphone signal 1311, 1313, 1315 is modified more than the left microphone audio signal 1301, 1303, 1305 because the right thickness is more than the left thickness.

In its simplest form these further embodiment additionally control the equalization based on detected directions. The equalization is implemented such that the difference in level in frequency bands between the left and right earcup transparency signal corresponds to a binaural signal from the detected direction. The level differences for the binaural signals are to be found from a stored database or suitable storage. The database may be a general one or personalized for the current user.

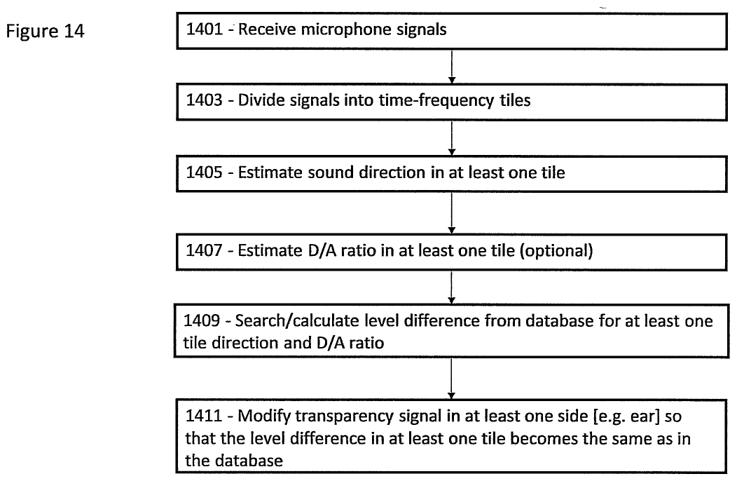

The method is further shown in the operations shown with respect to FIG. 14.

With respect to step 1401 there is shown the operation of receiving microphone signals from both ear cups (L and R).

Then with respect to step 1403 there is shown the operation of dividing signals into time-frequency tiles.

As shown in step 1405 is the operation of estimating sound direction in at least one tile.

Additionally is shown in step 1407 the operation of estimating D/A ratio in at least one tile. This estimation operation is an optional step.

Furthermore is shown in step 1409 the operation of searching/calculating (or otherwise obtaining or determining) a level and/or phase difference from a database for at least one tile direction (or suitable storage means).

Then as show in step 1411 is the operation of modifying transparency signal in one ear such that the level difference in at least one tile becomes the same as in the database.

In some embodiments the diffuseness of the transparency signal can also be modified based on measured diffuseness by decorrelating or correlating the transparency signal so that its diffuseness matches the measured diffuseness from the outer microphones. Decorrelating a signal can be implemented according to any suitable manner, for example employing decorrelators and correlating a signal can be done for example by mixing the signal stereo transparency signal with its mono downmix.

Where, the level difference between left and right ears is the bigger, the closer to the ear canal one measures it. Conversely, the phase difference gets the bigger, the further from the ear canal one measures it. Thus, the modification for the transparency signal in some embodiments increases the level difference for thicker headphones and decreases the phase difference for thicker headphones. The amount of increase and decrease may be frequency dependent and found from a database that has been measured (or modelled) and stored to the headphone memory.

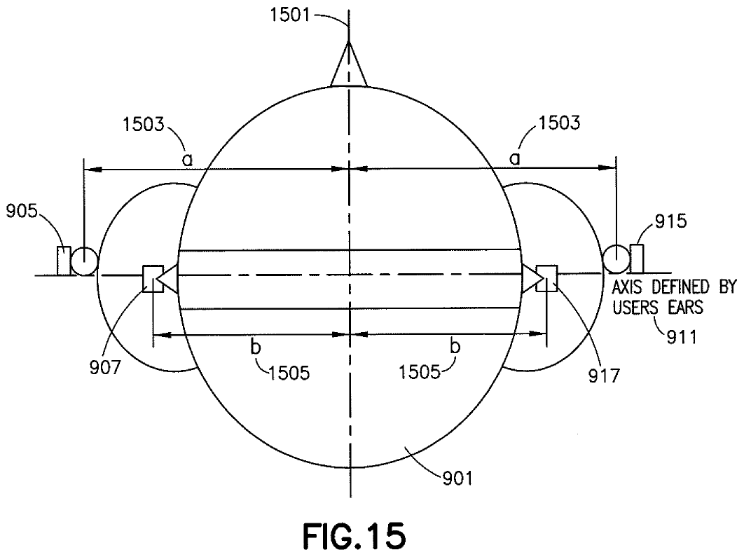

One possible implementation uses Mid/Side coding. For example, when the microphones and loudspeakers in the headphones are as in FIG. 15, left audio signal (l) from left earcup microphone 905 and right audio signal (r) from right earcup microphone 915 are converted into a Mid/Side representation:

$$M = \frac{1}{2} l + \frac{1}{2} r$$

$$S = \frac{1}{2} l - \frac{1}{2} r$$

Mid/side-representation is converted back into left loudspeaker 907 audio signal (L) and right loudspeaker 917 audio signal (R).

The distance between the centre line 1501 to the left or right microphone 905 or 915 is the distance a 1503 and distance between the centre line 1501 to the left or right speaker 907 or 917 is the distance b 1505

$$L = \frac{a}{b} M + \frac{b}{a} S$$

$$R = \frac{a}{b} M - \frac{b}{a} S$$

Additionally, some equalisation for the loudspeaker signals is needed because headphones acoustically let sound pass through them in differing amounts at different frequencies.

The use of the Mid/Side representation is effective in the sense that it both improves the perceived directions of sounds to be closer to reality but it also modifies the coherence of the sound to correspond better to what user would hear if the microphones were not so far away from the speakers (coherence needs to be increased the more the farther away microphones are from user's ears). Mid/Side representation is also very simple to compute and thus does not consume too much processing power or battery of the headphones. In some embodiments other implementations are possible but would be more processor intensive.

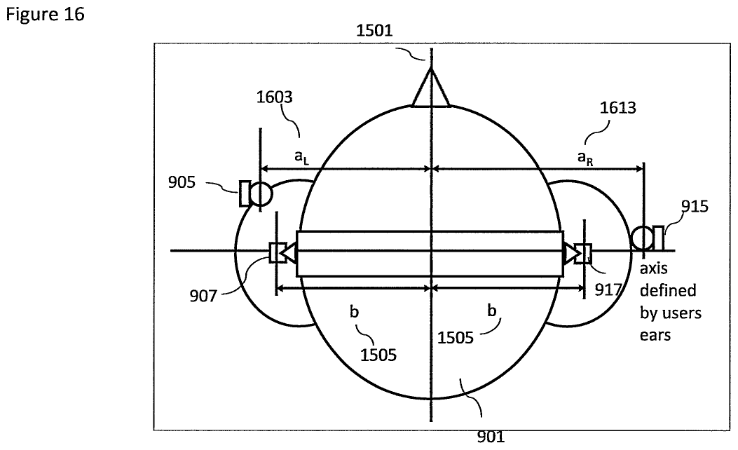

In some implementations the microphones may be asymmetrically placed as in FIG. 16 so that the distances a_{L} and a_{R} are different. Thus, distance between the centre line 1501 to the left and right microphone 905, 915 are the distance a_{L} 1603 and a_{R} 1613 and distance between the centre line 1501 to the left and right speaker 907, 917 is the distance b 1505.

In such cases different computation is needed according to the following formulas:

$$M = \frac{1}{2} l + \frac{1}{2} r$$

$$S = \frac{1}{2} l - \frac{1}{2} r$$

$$L = \frac{{a}_{L}}{b} M + \frac{2 b}{{a}_{L} + {a}_{R}} S$$

$$R = \frac{{a}_{L}}{b} M - \frac{2 b}{{a}_{L} + {a}_{R}} S$$

Thus where the microphones are outside the vehicle and the speakers are either in their normal positions (in doors, dashboard etc) or the speakers are in the driver's seat, the rendering of the microphone signals can differ. With the conventional position speaker configuration the microphone signals could be rendered to the speakers almost “as is” but for the speakers in the seat a stereo image should be narrowed significantly. The Mid Side examples discussed above can be applied with suitable microphone selection. For the normal speaker placement, the microphones that are widely dispersed on the vehicle outside surface can be selected but for the seat speakers example the selection can be for microphones that are closer to each other.

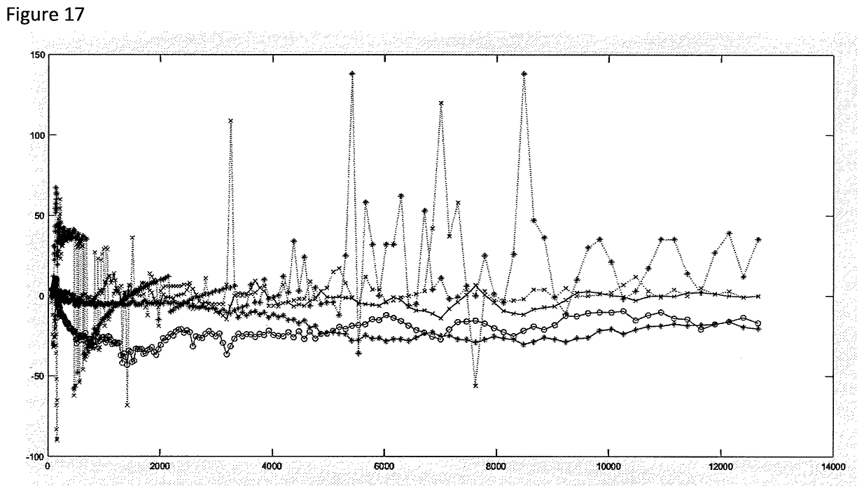

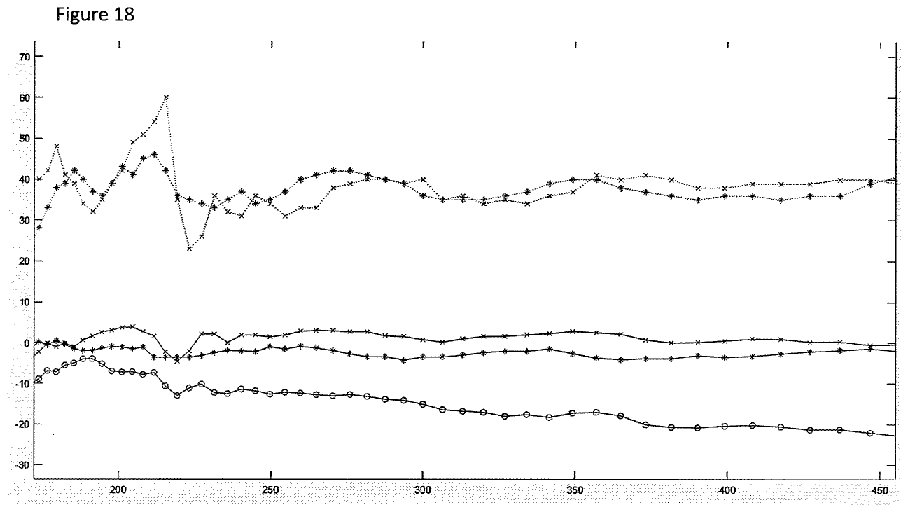

With respect to FIGS. 17 and 18 are shown example plots where:
solid line with ‘∘’ is the amount of leakage;
solid line with ‘*’ is the level difference between L and R ears without headphones;
solid line with ‘x’ is the level difference between L and R ears with headphones;
dashed line with ‘*’ is the phase difference between L and R ears without headphones;
dashed line with ‘x’ is the phase difference between L and R ears with headphones.

The pass-through signal ideally is such that when it acoustically combines with the leaked sound (leaked sound has the properties of the lines with x), the combination has the properties of the lines with *.

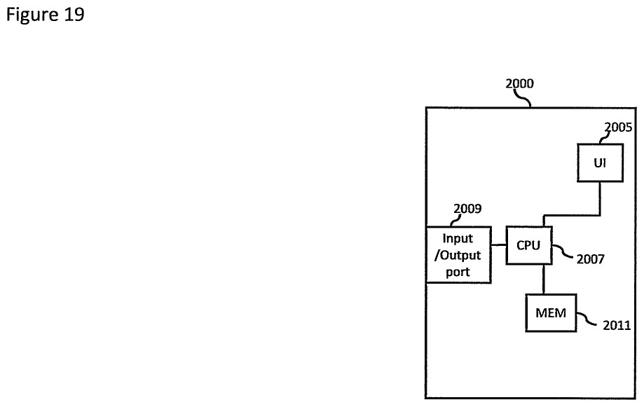

With respect to FIG. 19 an example electronic device which may be used as any of the apparatus parts of the system as described above. The device may be any suitable electronics device or apparatus. For example, in some embodiments the device 2000 is a mobile device, user equipment, tablet computer, computer, audio playback apparatus, etc. The device may for example be configured to implement the encoder or the renderer or any functional block as described above.

In some embodiments the device 2000 comprises at least one processor or central processing unit 2007. The processor 2007 can be configured to execute various program codes such as the methods such as described herein.

In some embodiments the device 2000 comprises a memory 2011. In some embodiments the at least one processor 2007 is coupled to the memory 2011. The memory 2011 can be any suitable storage means. In some embodiments the memory 2011 comprises a program code section for storing program codes implementable upon the processor 2007. Furthermore in some embodiments the memory 2011 can further comprise a stored data section for storing data, for example data that has been processed or to be processed in accordance with the embodiments as described herein. The implemented program code stored within the program code section and the data stored within the stored data section can be retrieved by the processor 2007 whenever needed via the memory-processor coupling.

In some embodiments the device 2000 comprises a user interface 2005. The user interface 2005 can be coupled in some embodiments to the processor 2007. In some embodiments the processor 2007 can control the operation of the user interface 2005 and receive inputs from the user interface 2005. In some embodiments the user interface 2005 can enable a user to input commands to the device 2000, for example via a keypad. In some embodiments the user interface 2005 can enable the user to obtain information from the device 2000. For example the user interface 2005 may comprise a display configured to display information from the device 2000 to the user. The user interface 2005 can in some embodiments comprise a touch screen or touch interface capable of both enabling information to be entered to the device 2000 and further displaying information to the user of the device 2000. In some embodiments the user interface 2005 may be the user interface for communicating.

In some embodiments the device 2000 comprises an input/output port 2009. The input/output port 2009 in some embodiments comprises a transceiver. The transceiver in such embodiments can be coupled to the processor 2007 and configured to enable a communication with other apparatus or electronic devices, for example via a wireless communications network. The transceiver or any suitable transceiver or transmitter and/or receiver means can in some embodiments be configured to communicate with other electronic devices or apparatus via a wire or wired coupling.

The transceiver can communicate with further apparatus by any suitable known communications protocol. For example in some embodiments the transceiver can use a suitable universal mobile telecommunications system (UMTS) protocol, a wireless local area network (WLAN) protocol such as for example IEEE 802.X, a suitable short-range radio frequency communication protocol such as Bluetooth, or infrared data communication pathway (IRDA).

The input/output port 2009 may be configured to receive the signals.

In some embodiments the device 2000 may be employed as at least part of the renderer. The input/output port 2009 may be coupled to headphones (which may be a headtracked or a non-tracked headphones) or similar.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general-purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, California automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
   I hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The term “non-transitory,” as used herein, is a limitation of the medium itself (i.e., tangible, not a signal) as opposed to a limitation on data storage persistency (e.g., RAM vs. ROM).

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1. A method for generating audio signals for a device equipped with a transparency mode, the method comprising:
obtaining at least two external audio signals from at least two microphones located on the device;
determining at least one of sound direction or diffuseness or distance between a first microphone and a second microphone of the at least two microphones based on the at least two external audio signals;
modifying at least one of the at least two external audio signals based on the determined at least one of sound direction, diffuseness, or distance; and
rendering the at least one modified audio signal.

2. The method as claimed in claim 1, wherein the at least two microphones located on the device are located on one side of the device.

3. The method as claimed in claim 1, wherein the at least two microphones located on the device are located on opposite sides of the device.

4. The method as claimed in claim 1, further comprising obtaining at least one internal audio signal, and modifying at least one of the at least two external audio signals is further based on the at least one internal audio signal.

5. The method as claimed in claim 1, comprising modifying the at least one of the at least two external audio signals further based on a frequency profile to modify the at least two external audio signals more in lower frequencies.

6. The method as claimed in claim 1, further comprising determining a distance between at least one of the at least two microphones located on the device and an associated speaker, wherein modifying at least one of the at least two external audio signals is based on the distance between at least one of the at least two microphones located on the device and the associated speaker.

7. The method as claimed in claim 1, wherein the device comprises one of:
a smartphone;
a headphone;
a vehicle equipped with the at least two microphones;
a helmet equipped with the at least two microphones; and
a personal protection equipment equipped with the at least two microphones.

8. The method as claimed in claim 1, wherein the first microphone and the second microphone of the at least two microphones are left and right side device microphones.

9. The method as claimed in claim 1, wherein the first microphone is a first set of microphones and the second microphone is a second set of microphones.

10. The method as claimed in claim 1, wherein modifying at least one of the at least two external audio signals based on the determined at least one of: sound direction, diffuseness, or distance is such that the modified audio signal direction or diffuseness is more correctly perceived with a user of the device.

11. An apparatus for generating audio signals for a device equipped with a transparency mode, the apparatus comprising:
at least one processor; and
at least one memory storing instructions that, when executed with the at least one processor, cause the apparatus at least to:
obtain at least two external audio signals from at least two microphones located on the device;
determine at least one of sound direction or diffuseness or distance between a first microphone and a second microphone of the at least two microphones based on the at least two external audio signals;
modify at least one of the at least two external audio signals based on the determined at least one of sound direction or diffuseness or distance; and
render the at least one modified audio signal.

12. The apparatus as claimed in claim 11, wherein the at least two microphones located on the device are located on one side of the device.

13. The apparatus as claimed in claim 11, wherein the at least two microphones located on the device are located on opposite sides of the device.

14. The apparatus as claimed in claim 11, wherein the instructions, when executed with the at least one processor, cause the apparatus to obtain at least one internal audio signal, and the instructions, when executed with the at least one processor, cause the apparatus to modify at least one of the at least two external audio signals based on the at least one internal audio signal.

15. The apparatus as claimed in claim 11, wherein the instructions, when executed with the at least one processor, cause the apparatus to modify at least one of the at least two external audio signals further based on a frequency profile to modify the at least two external audio signals more in lower frequencies.

16. The apparatus as claimed in claim 11, wherein the instructions, when executed with the at least one processor, cause the apparatus to determine a distance between at least one of the at least two microphones located on the device and an associated speaker, wherein the instructions, when executed with the at least one processor, cause the apparatus to modify at least one of the at least two external audio signals based on the distance between at least one of the at least two microphones located on the device and the associated speaker.

17. The apparatus as claimed in claim 11, wherein the device comprises one of:
a smartphone;
a headphone;
a vehicle equipped with the at least two microphones;
a helmet equipped with the at least two microphones; and
a personal protection equipment equipped with the at least two microphones.

18. The apparatus as claimed in claim 11, wherein the first microphone and the second microphone of the at least two microphones are left and right side device microphones.

19. The apparatus as claimed in claim 11, wherein the first microphone is a first set of microphones and the second microphone is a second set of microphones.

20. The apparatus as claimed in claim 11, wherein the instructions, when executed with the at least one processor, cause the apparatus to modify at least one of the at least two external audio signals based on the determined at least one of sound direction, diffuseness, or distance is such that the modified audio signal direction or diffuseness is more correctly perceived with a user of the device.
